(19) United States
(12) Patent Application Publication
(10) Pub. No.: US 2026/0320959 A1
(43) Pub. Date: Oct. 15, 2026

(54) INFORMATION PROCESSING SYSTEM AND INFORMATION PROCESSING METHOD

(71) Applicant: Sony Semiconductor Solutions Corporation, Kanagawa (JP)

(72) Inventors: Hideki OYAIZU, Tokyo (JP); Ryuichi TADANO, Tokyo (JP)

(73) Assignee: Sony Semiconductor Solutions Corporation, Kanagawa (JP)

(21) Appl. No.: 19/638,127

(22) Filed: Apr. 3, 2026

(30) Foreign Application Priority Data
Apr. 14, 2025 (JP) 2025-066112

(51) Int. Cl. G06V 10/147; G06F 21/62; G06V 10/40; G06V 40/10; G06V 40/16; G06V 40/20; H04N 25/78

(52) U.S. Cl. CPC G06V 10/147; G06F 21/6245; G06V 10/40; G06V 40/103; G06V 40/168; G06V 40/20; H04N 25/78

(57) ABSTRACT

An information processing system includes an optical filter that converts an image formed on the basis of incident light into a filter image by applying a filter effect set on a basis of a predetermined parameter; an imaging element that captures the filter image as an analog signal image including an analog signal; an A/D converter that applies A/D conversion processing of a predetermined bit depth to the analog signal image to convert the analog signal image into a digital signal image; and an attribute estimation unit that estimates an attribute of a person in the image from the digital signal image, in which the predetermined parameter and the predetermined bit depth are set to make it difficult to perform the personal identification of the person based on the digital signal image, and to enable the attribute estimation unit to estimate the attribute. The present disclosure can be applied to a monitoring camera.

### CROSS REFERENCE TO RELATED APPLICATIONS

This application claims the benefit of Japanese Priority Patent Application JP 2025-066112 filed on Apr. 14, 2025, the entire contents of which are incorporated herein by reference.

### TECHNICAL FIELD

The present disclosure relates to an information processing system and an information processing method, and more particularly, to an information processing system and an information processing method capable of extracting a predetermined attribute from a person while protecting privacy.

### BACKGROUND ART

Cameras for various purposes such as crime prevention, watching at home, and customer analysis have been widely and generally spread. Among them, in a case of a surveillance camera used for crime prevention or the like, one requirement is to identify an individual from a captured person image.

However, on the other hand, in a case of a watching camera for home, since the main purpose is to sense an abnormality of a person, detect a behavior, and the like, and the watching camera is often used in a private space, the need to identify an individual person is low, and on the other hand, the demand for privacy protection is high.

Furthermore, in a case of a customer analysis camera used in a retail store, it is desirable that necessary information can be collected while protecting the privacy of the customer.

Thus, a camera capable of extracting necessary information while protecting privacy is desired. Therefore, a technology is disclosed in which a face region is detected by a face detector from a captured image, the detected face region and a background area are separated, a face with privacy protection applied and a face without privacy protection, and a background are separately output, and privacy can be protected while necessary information is extracted (see Patent Literature 1).

### CITATION LIST

### Patent Literature

### [PTL 1]

JP 2009-194687 A

### SUMMARY

### Technical Problem

However, since the technology disclosed in Patent Literature 1 performs the privacy protection process after an image to be captured is once captured in the camera, there is a possibility that a captured image not subjected to privacy protection is illegally extracted from the camera and leaked, and therefore, there is a possibility that privacy protection cannot be appropriately realized.

The present disclosure has been made in view of such a situation, and in particular, enables extraction of a predetermined attribute from a person while protecting privacy.

### Solution to Problem

According to one aspect of the present disclosure, there is provided an information processing system including: an optical filter that converts an image formed on a basis of incident light into a filter image by applying a filter effect set on the basis of a predetermined parameter; an imaging element that captures the filter image as an analog signal image including an analog signal; an A/D converter that applies A/D conversion processing of a predetermined bit depth to the analog signal image to convert the analog signal image into a digital signal image that is an image including a digital signal; and an attribute estimation unit that estimates an attribute of a person in the image from the digital signal image, in which the predetermined parameter and the predetermined bit depth are set to make it difficult to perform the personal identification of the person based on the digital signal image, and to enable the attribute estimation unit to estimate the attribute. According to another aspect of the present disclosure, there is provided an information processing method for an information processing system including: an optical filter that converts an image formed on the basis of incident light into a filter image by applying a filter effect set on a basis of a predetermined parameter; and an imaging element that captures the filter image as an analog signal image including an analog signal, the method including: performing A/D conversion processing of converting the analog signal image into a digital signal image that is an image including a digital signal by applying A/D conversion processing of a predetermined bit depth to the analog signal image; and performing attribute estimation processing of estimating an attribute of a person in the image from the digital signal image, in which the predetermined parameter and the predetermined bit depth are set to make it difficult to identify an individual of the person based on the digital signal image and to enable the attribute to be estimated by the attribute estimation processing.

In one aspect of the present disclosure, an image formed on the basis of incident light is converted into a filter image by applying a filter effect set on the basis of a predetermined parameter by an optical filter, the filter image is captured as an analog signal image including an analog signal, the analog signal image is subjected to A/D conversion processing of a predetermined bit depth to be converted into a digital signal image which is an image including a digital signal, an attribute of a person in the image is estimated from the digital signal image, and the predetermined parameter and the predetermined bit depth are set so that it is difficult to perform the personal identification of the person based on the digital signal image and the attribute can be estimated by the attribute estimation unit.

### BRIEF DESCRIPTION OF DRAWINGS

FIG. 1 is a diagram illustrating an outline of the present disclosure.

FIG. 2 is a diagram illustrating an information processing system of the present disclosure.

FIG. 3 is a diagram illustrating an example of a privacy protection image.

FIG. 4 is a diagram illustrating a change in a privacy protection image generated in a case where a quantization level number of A/D conversion processing of a low bit depth and (λ, σ) are changed.

FIG. 5 is a diagram illustrating a change in a privacy protection image generated in a case where the quantization level number of the A/D conversion processing of the low bit depth and (λ, σ) are changed.

FIG. 6 is a flowchart illustrating attribute recognition processing by the information processing system in FIG. 2.

FIG. 7 is a diagram illustrating a configuration example of a general-purpose computer.

### DESCRIPTION OF EMBODIMENTS

Hereinafter, preferred embodiments of the present disclosure will be described in detail with reference to the accompanying drawings. Note that, in the present specification and the drawings, components having substantially the same functional configurations are denoted by the same reference signs, and redundant description is omitted.

Hereinafter, modes for carrying out the present technology will be described. The description will be given in the following order.
1. Outline of present disclosure
2. Preferred embodiment
3. Description of computer to which present technology is applied

### 1. Outline of Present Disclosure

In particular, the present disclosure enables extraction of a predetermined attribute from a person while protecting privacy.

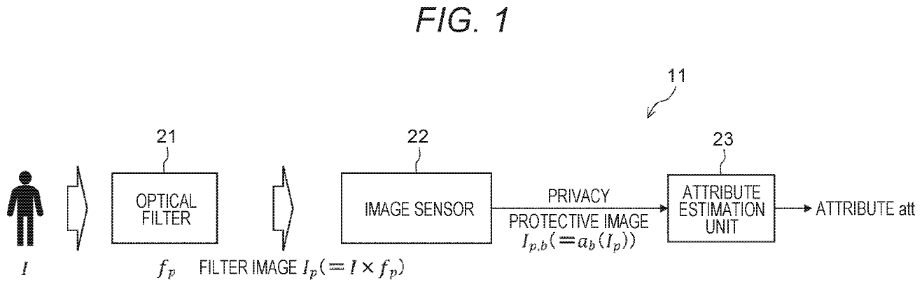

First, in describing details of the information processing system of the present disclosure, an outline will be described. The information processing system 11 in FIG. 1 captures an image including a person as a privacy protection image in which an individual of the person is not specified, and recognizes (extracts) a predetermined attribute related to the person from the captured privacy protection image.

More specifically, as illustrated in FIG. 1, the information processing system 11 includes an optical filter 21, an image sensor 22, and an attribute estimation unit 23.

The optical filter 21 converts the image I configured by the incident light into a filter image Iₚ by applying a filter effect fₚ, and transmits the filter image Iₚ to the image sensor 22.

The image sensor 22 captures the filter image Iₚ as an image including an analog signal, moreover, converts the filter image Iₚ into a privacy protection image I_{p,b} including a digital signal by low-bit A/D conversion processing a_{b}, and outputs the privacy protection image I_{p,b} to the attribute estimation unit 23.

The attribute estimation unit 23 recognizes (extracts) a predetermined attribute att related to the person on the basis of the privacy protection image I_{p,b}.

In the configuration as described above, the image sensor 22 converts the filter image Iₚ into a privacy protection image I_{p,b} including a digital signal that can sufficiently protect the privacy of the person in the image I and can sufficiently extract a predetermined attribute att related to the person in the attribute estimation unit 23, and outputs the privacy protection image I_{p,b}.

That is, according to the information processing system 11 of the present disclosure, the image I configured by the incident light is converted into the privacy protection image I_{p,b} by the processing combining the application of the filter effect fₚ by the optical filter 21 and the low-bit A/D conversion processing a_{b}, and is output from the image sensor 54, and the predetermined attribute att regarding the person is extracted. Therefore, since the image output from the image sensor 54 is the privacy protection image I_{p,b}, even if the image is illegally leaked, it is possible to protect the privacy of the person in the image I.

Furthermore, since the image output from the image sensor 54 is the privacy protection image I_{p,b} including a digital signal capable of sufficiently extracting a predetermined attribute att related to the person in the attribute estimation unit 23, it is possible to recognize (extract) the predetermined attribute att related to the person.

As a result, according to the present disclosure, it is possible to recognize (extract) a predetermined attribute from a person while protecting privacy.

### 2. Preferred Embodiment

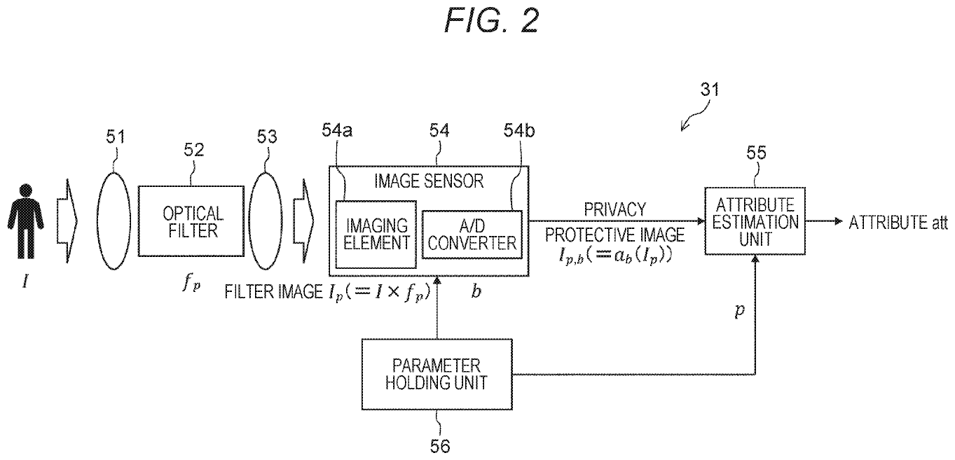

Next, a detailed configuration of the information processing system of the present disclosure will be described with reference to FIG. 2. The information processing system 31 includes a lens 51, an optical filter 52, a lens 53, an image sensor 54, an attribute estimation unit 55, and a parameter holding unit 56. The lens 51 condenses incident light configuring the image I so as to transmit the incident light to the optical filter 52.

Note that, since it is assumed that the information processing system 31 is configured to recognize (extract) the attribute of the person, basically, it is assumed that a person to be observed for extracting the attribute exists (is reflected) in the image I, but the image I is not necessarily an image in which the person exists. However, in a case where there is no person in the image I, no attribute is extracted from the image I. Moreover, the type of the region of the person to be observed existing in the image I may be a face image of the person in the image I (a face region in the image I), an upper body image of the person (an upper body region of the person in the image I), or a whole-body image (a whole-body region of the person in the image I).

In the following description, in a case where the image is an image of a person, it is assumed that the image includes all of a face image, an upper body image, and a whole-body image, but the image may be limited to at least one or more of them. However, the type of the extractable attribute varies depending on the types of the face image, the upper body image, and the whole-body image of the person to be observed present in the image I.

The optical filter 52 is an optical filter designed on the basis of parameters specified by applying the Gabor filter, and in order to protect the privacy of a person while enabling extraction of a predetermined attribute related to the person included in the image I, a filter effect fₚ that reduces the visibility by a human and the ability to extract personal information using image processing is imparted to the image I, so that the image I is converted into a filter image Iₚ and transmitted. The lens 53 condenses incident light configuring the image Iₚ generated by applying the filter effect fₚ in the optical filter 52 on the imaging surface of the image sensor 54.

The image sensor 54 captures the image Iₚ as an image including an analog signal, and moreover performs low-bit analog/digital (A/D) conversion processing to convert the image Iₚ into the privacy protection image I_{p,b} (=a_{b} (I*fₚ)) including a digital signal, and outputs the privacy protection image I_{p,b} (=a_{b} (I*fₚ)) to the attribute estimation unit 55.

More specifically, the image sensor 54 includes an imaging element 54a and an A/D converter 54b.

The imaging element 54a includes, for example, a complementary metal oxide semiconductor (CMOS) or the like, captures the image Iₚ as an image including an analog signal, and supplies the image Iₚ to the A/D converter 54b.

The A/D converter 54b reads the parameter b held in the parameter holding unit 56, and applies analog/digital (A/D) conversion processing a_{b} with a low bit depth to the image Iₚ including an analog signal on the basis of the parameter b, thereby converting the image Iₚ into the privacy protection image I_{p,b} (=a_{b} (I*fₚ)) including a digital signal. Here, the low bit depth is the bit depth of the A/D conversion processing in which an individual cannot be specified from the privacy protection image according to the presented image size, the type of the image, the optical filter 52, and the attribute attr obtained from the attribute estimation unit 55, and the accuracy rate of the attribute attr is set to be higher than a predetermined value, and is, for example, 4 bits or less. That is, in the case of the A/D conversion processing with a higher bit depth, the image as the A/D conversion processing result is converted into an image that can be individually specified. On the other hand, in the case of the A/D conversion processing with a lower bit depth, the image as the A/D conversion processing result is converted into an image in which the individual cannot be specified. However, there is a possibility that the attribute attr cannot be obtained from the attribute estimation unit 55 if the image as the A/D conversion processing result is simply an image in which the individual cannot be specified. Therefore, the A/D conversion processing with a low bit depth here is A/D conversion processing with a lower bit depth with respect to A/D conversion processing with a high bit depth in which an image as a result of the A/D conversion processing is converted into an image enabling individual identification, and is A/D conversion processing in which an image as a result of the A/D conversion processing is an image in which an individual cannot be identified and the accuracy rate of the attribute attr is higher than a predetermined value, that is, an A/D conversion processing to be a privacy protection image.

The privacy protection image I_{p,b} is an image in which the attribute estimation unit 55 can recognize (extract) a predetermined attribute related to a person included in the image I before the filter effect fₚ by the optical filter 52 is applied while enabling the protection of the privacy of the person.

Note that a_{b} (x) represents A/D conversion processing by the A/D converter 54b on the image x including an analog signal using the parameter b. Furthermore, as described above, the parameter b regarding the A/D conversion processing in the A/D converter 54b in the image sensor 54 will be described in detail later together with the configuration of the optical filter 52.

The attribute estimation unit 55 includes, for example, an estimation model formed by machine learning or the like, reads the parameter p related to the design for giving the filter effect fₚ by the optical filter 52 from the parameter holding unit 56, and estimates the attribute related to the person included in the image I by the attribute estimation processing based on the read parameter p.

With the above configuration, an image I formed on the basis of incident light is converted into a filter image Iₚ by applying, by the optical filter 52 designed using a Gabor filter, a filter effect to the image I. The filter image Iₚ is then captured by the image sensor 54 as an image including an analog signal, and is further converted into a privacy protection image I_{p,b} by low-bit A/D conversion processing by the A/D converter 54b using the parameter b, and output. Therefore, the privacy protection image I_{p,b} can be expressed by the following Expression (1).

[Math. 1]

I_{p,b}=a_{b}(I*fₚ) (1)

Here, “*” is a convolution operator representing that the filter effect fₚ is applied to the image I. Furthermore, the parameters related to the design of the optical filter 52 will be described in detail later together with the configuration of the A/D converter 54b in the image sensor 54.

With the above configuration, since the image output from the image sensor 54 is the privacy protection image I_{p,b} and is not the image I, it is possible to protect privacy even if the image flows out to the outside.

Furthermore, the attribute estimation unit 55 can recognize (extract) the attribute from the privacy protection image I_{p,b} by estimation processing based on the parameter p related to the design of the optical filter 52.

As a result, according to the present disclosure, it is possible to extract a predetermined attribute from a person while protecting privacy.

### <Privacy Protection Image>

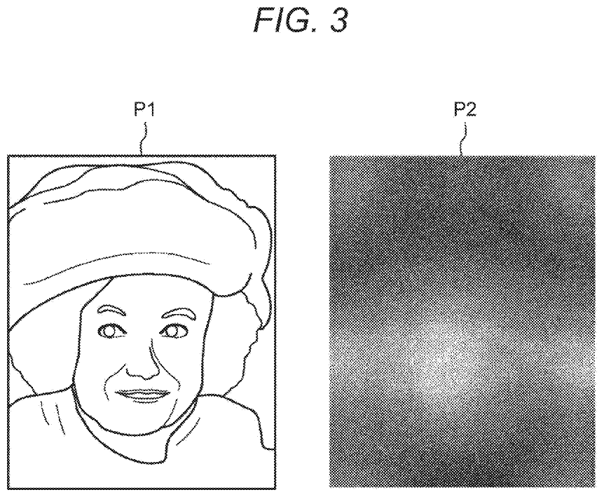

The privacy protection image I_{p,b} is an image from which an individual cannot be identified. More specifically, the privacy protection image I_{p,b} is, for example, an image as illustrated in FIG. 3. In FIG. 3, the image P1 on the left side is an image corresponding to the image I configured by the incident light in FIG. 2, and the image P2 on the right side is an image corresponding to the privacy protection images I_{p,b} for the image I in FIG. 2. That is, as illustrated in FIG. 3, the privacy protection image I_{p,b} is an image that cannot identify an individual from the images.

Here, as an example of a criterion for determining whether or not individual identification is possible from an image, there is a subjective evaluation experiment method of presenting a total of three images of two privacy protection images in which different persons appear and an original image in which privacy of a person appearing in one of the two privacy protection images is not protected, and identifying which privacy protection image shows a person in the original image.

That is, there has been proposed a subjective evaluation method of comparing confidentiality between images by presenting two different privacy protection images and one original image and performing a subjective evaluation experiment on which of the two privacy protection images is easier to identify a person. By using this subjective evaluation method, the effectiveness of the privacy protection image may be evaluated, and whether or not an individual can be statistically identified may be determined.

Note that, for details of this subjective evaluation method, please refer to Reiji Tanaka, Satoshi Sato, and Yasunori Ishii, “Study on Privacy Protection Indicators for Multi-Pinhole Cameras,” Research Report Computer Graphics and Visual Informatics (CG) 2020.10(2020):1-6.

### (Regarding Attribute)

The attribute in the present specification is body feature information and behavior feature information recognized (extracted) on the basis of information (information in which privacy is protected) in which information that can be individually identified is excluded from the information obtained from the image. Here, the body feature information is, for example, information regarding physical features of a person such as gender, facial expression, race, the number of persons, whether or not the person wears glasses, and the like. Furthermore, the behavior feature information is, for example, information regarding a feature of behavior of a person such as gait, movement, face orientation, whether or not eyes are opened, whether or not the person is smiling, and the like.

However, the attribute is not limited to the above, and information other than the above may be used as long as the information can be classified as information related to a physical feature of a person (body feature information) and information related to a feature of a behavior of a person (behavior feature information).

### <Optical Filter and A/D Converter>

The optical filter 52 is an optical filter to which a Gabor filter is applied. The function expressing the Gabor filter is generally defined as the following Expression (2).

$$[ Math . 2 ]$$

$$g ( x , y , λ , σ , γ , ψ ) = exp ( - \frac{{x}^{′2} + {γ}^{2} {y}^{′ 2}}{2 {σ}^{2}} ) cos ( 2 π \frac{{x}^{′}}{λ} + ψ ) \qquad ( 2 )$$

Here, g (x, y, λ, σ, γ, ψ) is a function representing the Gabor filter, and in the parameters x, y, λ, σ, γ, and ψ, (x, y) represents coordinates of a pixel position, λ represents a spatial frequency, σ represents a standard deviation of Gaussian, γ represents an aspect ratio, and ψ represents a phase. Furthermore, “′” indicates one-time differentiation.

That is, Expression (2) is basically a function defined as a product of a term (term of exp) of a Gaussian function (Gaussian envelope) and a term (term of cos) of a trigonometric function (carrier wave).

As shown in Expression (2), a function representing the Gabor filter includes a trigonometric function term and has a negative value, and thus cannot be simply applied to an optical filter. There is also a method of physically using phase shift, interference, or the like, but since coherent light is a premise, the method cannot be applied to a case of handling general light. Therefore, in the optical filter 52 of the present disclosure, as indicated by the following Expression (3), a function obtained by modifying the function representing the general Gabor filter expressed by Expression (2) is used.

$$[ Math . 3 ]$$

$${g}_{m} ( x , y , λ , σ , γ , ψ ) = exp ( - \frac{{x}^{′2} + {γ}^{2} {y}^{′ 2}}{2 {σ}^{2}} ) ( cos ( 2 π \frac{{x}^{′}}{λ} + ψ ) + 1 ) \qquad ( 3 )$$

Here, gₘ (x, y, λ, σ, γ, ψ) is a function to which the Gabor filter applied to the optical filter 52 of the present disclosure is applied, and regarding the parameters x, y, λ, σ, γ, and ψ, (x, y) represents a coordinate position of a pixel, λ represents a spatial frequency, σ represents a standard deviation of Gaussian, γ represents an aspect ratio, and ψ represents a phase. Furthermore, “′” indicates a first differentiation. That is, as expressed by Expression (3), in the optical filter 52, the value range of the function expressing gₘ (x, y, λ, σ, γ, ψ) is set to 0 or more by adding 1 to the term of the trigonometric function of Expression (2) that defines the function of the Gabor filter, so that the function can be used as the optical filter. Hereinafter, the function defined by the Expression (3) is also referred to as a function of the modified Gabor filter.

Furthermore, the parameters σ, λ, γ, ψ in Expression (3) are selected so that the privacy of the person in the image I can be sufficiently protected and the recognition rate (recognition accuracy) of the attribute att in the attribute estimation unit 55 can be sufficiently obtained (so that the estimation accuracy becomes sufficient). Note that, here, sufficiently protecting the privacy of the person in the image I means, for example, that the individual identification rate of the person in the privacy protection image I_{p,b} is a predetermined value or less. Furthermore, in the attribute estimation unit 55, the fact that the predetermined attribute att related to the person can be sufficiently extracted means that, for example, in the attribute estimation unit 55, a recognition rate (estimation accuracy) of the predetermined attribute att related to the person in the privacy protection image I_{p,b} is a predetermined value or more.

The optical filter 52 is designed on the basis of the parameters σ, λ, γ, and ψ set in this manner. Note that the parameters σ, λ, γ, and ψ in Expression (3) are expressed as a parameter p (=(σ, λ, γ, ψ)) related to the optical filter fₚ in FIG. 2.

However, an attempt is made to generate the privacy protection image only with the optical filter 52 to which the function of the modified Gabor filter defined in Expression (3) is applied, then the DC component of the person image to be observed remains, and thus, there is a case where individual identification becomes possible. Therefore, the A/D converter 54b executes the A/D conversion processing with a low bit depth, thereby generating a privacy protection image that is difficult to identify an individual.

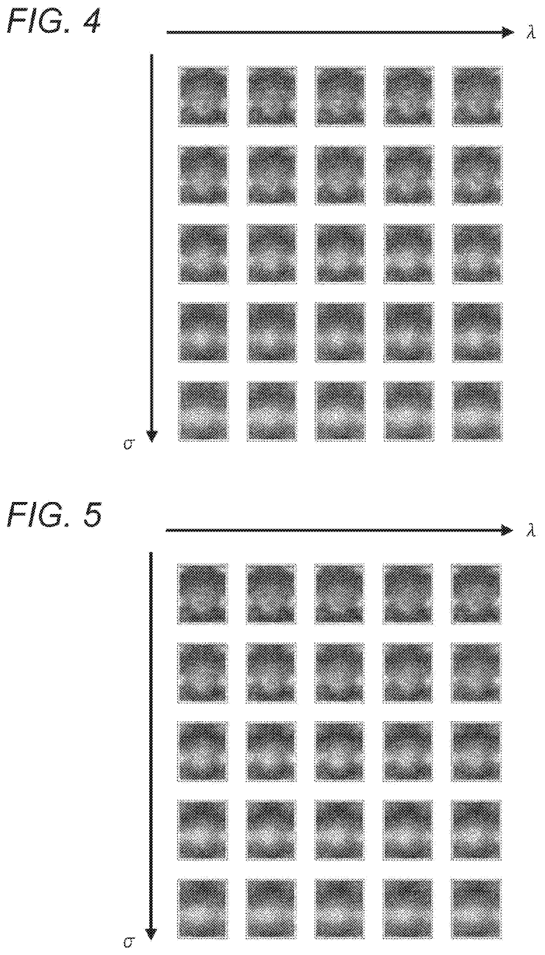

For example, the quantization level number of the A/D conversion processing of a low bit depth executed by the A/D converter 54b is set to 8, (λ, σ) is changed, and the function of the modified Gabor filter of Expression (3) is applied to the optical filter 52, then the privacy protection image is generated to be changed as illustrated in FIG. 4.

Furthermore, for example, in a case where the quantization level number of the A/D conversion processing of a low bit depth executed by the A/D converter 54b is set to 256, (λ, σ) is changed, and the function of the modified Gabor filter of Expression (3) is applied to the optical filter 52, the privacy protection image is generated to be changed as illustrated in FIG. 5.

FIGS. 4 and 5 each illustrate a change in the privacy protection image generated in a case where (λ, σ) is changed in five stages for each quantization level number of the A/D conversion processing of a low bit depth executed by the A/D converter 54b.

Here, the quantization level number of the A/D conversion processing of the low bit depth is set as the parameter b set for the A/D converter 54b. That is, the A/D converter 54b performs A/D conversion processing of a low bit depth on the image Iₚ including the analog signal with the quantization level number specified by the parameter b stored in the parameter holding unit 56, and converts the image Iₚ into the privacy protection image I_{p,b}. Note that the parameter b is determined by the size of the image to be presented, the type of the image, the optical filter, and the attribute attr obtained from the attribute estimation unit 55. For example, as a result of a subjective evaluation experiment, an individual cannot be specified from the privacy protection image, and an appropriate numerical value is obtained from the accuracy rate of the attribute attr.

However, from the privacy protection image that changes in this way, it is necessary for the attribute estimation unit 55 to change the parameter p to be adopted for the optical filter 52 depending on the type of the attribute to be extracted.

For this reason, the parameter b corresponding to the quantization level number of the A/D conversion processing of the low bit depth set in the A/D converter 54b and the parameter p to be adopted in the optical filter 52 are made to correspond to each other, and those that can sufficiently protect privacy and sufficiently obtain (sufficiently extract) the recognition rate of the attribute to be recognized (to be extracted) are selected.

For example, machine learning may be used to select the parameters b and p. That is, while the parameter p (=(σ, λ, γ, ψ)) of the modified Gabor filter function for setting the optical filter 52 and the parameter b corresponding to the quantization level number of the A/D conversion processing of a low bit depth set in the A/D converter 54b are changed, the parameters b and p are selected such that privacy can be sufficiently protected by machine learning and a recognition rate in the attribute estimation unit 55 can be sufficiently obtained (estimation accuracy is sufficient).

Furthermore, at this time, the parameter p related to the function of the modified Gabor filter of Expression (3) and the parameter b serving as the quantization level related to the A/D conversion processing in the A/D converter 54b may be set and held in the parameter holding unit 56 for each type of attribute to be recognized (to be extracted).

However, in a case where the parameter related to the function of the modified Gabor filter is changed, it is necessary to replace the optical filter 52 with one designed in association.

Then, the attribute estimation unit 55 reads the parameter p related to the function of the modified Gabor filter of the corresponding expression (3) from the parameter holding unit 56 according to the attribute for which recognition has been instructed (attribute for which extraction has been instructed), and uses the parameter p for attribute estimation. Furthermore, at this time, the A/D converter 54b also reads the parameter b specifying the quantization level of the A/D conversion processing according to the attribute for which recognition has been instructed (attribute for which extraction has been instructed) from the parameter holding unit 56 and uses the parameter b for the A/D conversion processing.

### <Attribute Recognition Processing>

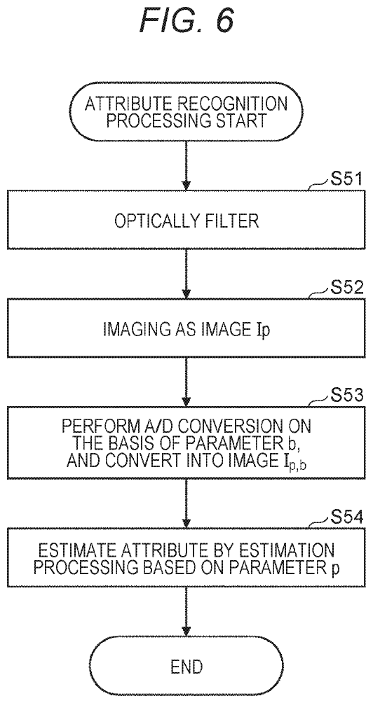

Next, attribute recognition processing by the information processing system 31 of FIG. 2 will be described with reference to a flowchart of FIG. 6.

Note that, in this processing, it is assumed that the type of the attribute desired to be recognized (desired to be extracted) is specified, and the parameters b and p are selected and held in the parameter holding unit 56 so that privacy can be sufficiently protected and a recognition rate in the attribute estimation unit 55 can be sufficiently obtained (estimation accuracy is sufficient). Furthermore, the optical filter 52 is assumed to be designed by a parameter p (=(σ, λ, γ, ψ)). In step S51, the lens 51 condenses the image I including the person formed by the incident light so as to transmit the image I through the optical filter 52. Then, during passing through the optical filter 52, the image I is given a filter effect fₚ according to the characteristics of the optical filter 52 designed by the parameter p, and is transmitted as a filter image Iₚ (=I*fₚ).

In step S52, the lens 53 condenses the incident light, which is transmitted through the optical filter 52 and forms the filter image Iₚ generated by being given the filter effect fₚ by the optical filter 52, on the imaging surface of the image sensor 54. The imaging element 54a of the image sensor 54 captures an image of the condensed incident light transmitted through the lens 53 as a filter image Iₚ including an analog signal.

In step S53, on the basis of the parameter b supplied from the parameter holding unit 56, the A/D converter 54b performs low-bit A/D conversion processing for protecting the privacy of a person while enabling extraction of a predetermined attribute related to the person included in the image I before the filter effect fₚ is applied to the image Iₚ including an analog signal, thereby converting the image Iₚ into a privacy protection image I_{p,b} (=a_{b} (I*fₚ)) including a digital signal and outputting the privacy protection image I_{p,b} to the attribute estimation unit 55.

In step S54, the attribute estimation unit 55 reads the parameter p related to the filter effect fₚ of the optical filter 52 from the parameter holding unit 56, and estimates the attribute on the basis of the parameter p. According to the above processing, the image output from the image sensor 54 is the privacy protection image I_{p,b} and is not the image I. Therefore, even if the image is leaked to the outside, privacy can be protected. Furthermore, the attribute estimation unit 55 can recognize (extract) the attribute of the person in the image I from the privacy protection image I_{p,b} by the estimation processing based on the parameter p related to the design of the optical filter 52.

As a result, according to the attribute recognition processing of the present disclosure, it is possible to extract a predetermined attribute from a person while protecting privacy.

<<3. Description of Computer to which Present Technology is Applied>>

The series of processing described above may be performed by hardware, or may be performed by software. In a case where the series of processing is executed by software, a program configuring the software is installed in a computer. Here, the computer includes a computer incorporated in dedicated hardware, a general-purpose personal computer capable of executing various functions by installing various programs, and the like, for example.

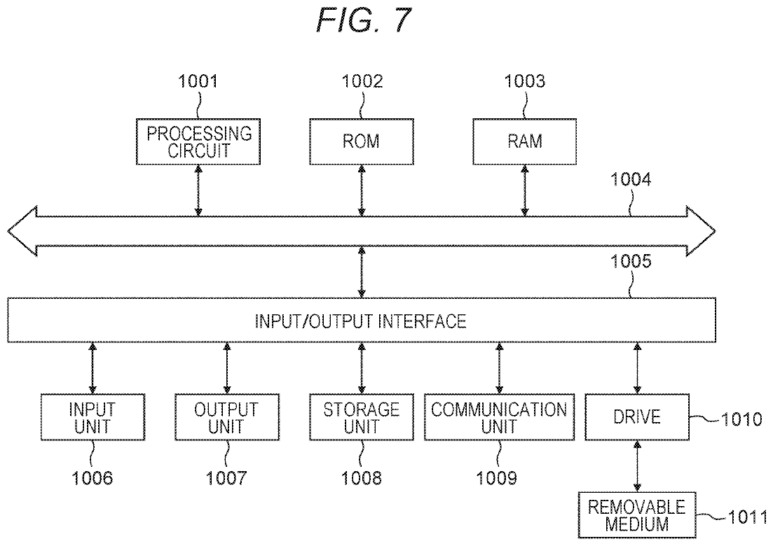

FIG. 7 is a block diagram illustrating a configuration example of hardware of a computer that executes the above-described series of processing by a program.

In the computer, a processing circuit 1001, a read only memory (ROM) 1002, and a random access memory (RAM) 1003 are mutually connected by a bus 1004.

An input/output interface 1005 is further connected to the bus 1004. An input unit 1006, an output unit 1007, a storage unit 1008, a communication unit 1009, and a drive 1010 are connected to the input/output interface 1005. The input unit 1006 can include a physical or virtual operation unit operated by the user to input information, such as a keyboard, a mouse, or a touch panel, and further, a means by which the user inputs information by voice, a line-of-sight, or the like. Furthermore, the input unit 1006 can include a sensor for inputting various physical quantities to the computer. For example, the input unit 1006 can include a sensor that acquires physical quantities such as light (including infrared rays other than visible light and the like), sound, and the like, such as a camera, a microphone, and the like. Furthermore, for example, the input unit 1006 can include a sensor that acquires other physical quantities such as temperature, moisture amount, acceleration, and distance. The output unit 1007 can include a unit that presents information to the user by stimulating the user's perception, such as a display, a speaker, or a haptics device. The storage unit 1008 includes a hard disk, a nonvolatile or volatile memory, or the like, and stores various types of information (including programs). The communication unit 1009 is a network interface or the like, and performs communication with the outside in a wired or wireless manner. The drive 1010 drives a removable medium 1011 such as a magnetic disk, an optical disk, a magneto-optical disk, or a semiconductor memory.

The processing circuit 1001 includes a processor such as a central processing unit (CPU) or a digital signal processor (DSP) that executes a program. (The processor of) the processing circuit 1001 loads and executes the program stored in the storage unit 1008 into the RAM 1003 via the input/output interface 1005 and the bus 1004, thereby performing the above-described series of processing. The processing circuit 1001 can output the processing result of the series of processing from the output unit 1007 via the bus 1004 and the input/output interface 1005, for example, as necessary. Furthermore, the processing circuit 1001 can store the processing result in the storage unit 1008, transmit the processing result from the communication unit 1009, or the like. The program executed by the computer (processing circuit 1001) can be provided by being recorded in the removable medium 1011 as a package medium or the like, for example. Furthermore, the program can be provided via a wired or wireless transmission medium such as a local area network, the Internet, or digital satellite broadcasting. In the computer, the program can be installed in the storage unit 1008 via the input/output interface 1005 by attaching the removable medium 1011 to the drive 1010. Furthermore, the program can be received by the communication unit 1009 from another device such as a server via a wired or wireless transmission medium and installed in the storage unit 1008. Besides, the program can be installed into the ROM 1002 or the storage unit 1008 in advance.

The program executed by the computer may be a program in which processing is performed in time series in the order described in the present specification, or may be a program in which processing is performed in parallel or at necessary timing such as when a call is made.

The processing performed by the computer according to the program does not necessarily need to be performed in time series in the order described as the flowchart. That is, the processing performed by the computer according to the program also includes processing executed in parallel or individually (for example, parallel processing or processing by an object).

The program may be processed by one computer (processor) or may be processed in a distributed manner by a plurality of computers. Moreover, the program may be transmitted to a remote computer to be executed.

In a case where the above-described series of processing is performed by the computer executing the program, (the processor of) the processing circuit 1001 functions as the attribute estimation unit 55 in FIG. 2 by executing the program.

In the present specification, the system means one component or a set of a plurality of components (devices, modules (parts), etc.). Thus, one or more components of a computer, for example, only a processor, or a combination of a processor and a memory, for example, only the processing circuit 1001, or a combination of the processing circuit 1001 to the bus 1004, and so on, is a system. For a set of a plurality of components, it does not matter whether or not all the components are in the same housing. Therefore, a plurality of devices housed in separate housings and connected via a network, one device in which a plurality of modules is housed in one housing, or the like is a system. Furthermore, for example, an entire computer or a combination of a computer and another device such as a server (not illustrated) is also a system.

Furthermore, for example, each step in one flowchart may be executed by one device, or may be executed by being shared by a plurality of devices. Moreover, in a case where a plurality of pieces of processing is included in one step, the plurality of pieces of processing may be executed by one device, or may be shared and executed by a plurality of devices. In other words, the plurality of pieces of processing included in one step can also be executed as pieces of processing of a plurality of steps. Conversely, the processing described as a plurality of steps can be collectively executed as one step. Furthermore, for example, in a program executed by the computer, processing of steps describing the program may be executed in a time-series order in the order described in the present specification, or may be executed in parallel or individually at a required timing such as when a call is made. That is, the pieces of processing of the respective steps may be executed in an order different from the above-described order as long as there is no contradiction. Furthermore, the processing of steps describing this program may be executed in parallel with the processing of another program, or may be executed in combination with the processing of another program.

Moreover, for example, a plurality of techniques related to the present disclosure can be each independently implemented alone as long as there is no contradiction. Of course, any plurality of the present disclosures can be implemented in combination. For example, some or all of the present disclosure described in any of the embodiments can be implemented in combination with some or all of the present disclosure described in other embodiments. Furthermore, some or all of the above-described arbitrary present disclosure can be implemented in combination with other techniques not described above. Note that the present disclosure can also have the following configurations.
<1> An information processing system including:
an optical filter that converts an image formed on a basis of incident light into a filter image by applying a filter effect set on the basis of a predetermined parameter;
an imaging element that captures the filter image as an analog signal image including an analog signal;
an A/D converter that applies A/D conversion processing of a predetermined bit depth to the analog signal image to convert the analog signal image into a digital signal image that is an image including a digital signal; and an attribute estimation unit that estimates an attribute of a person in the image from the digital signal image, in which
the predetermined parameter and the predetermined bit depth are set to make it difficult to perform the personal identification of the person based on the digital signal image, and to enable the attribute estimation unit to estimate the attribute.
<2> The information processing system according to <1>, in which
the optical filter converts the image into the filter image by applying the filter effect having an optical characteristic defined by applying the predetermined parameter to a function obtained by modifying a function defining a Gabor filter.
<3> The information processing system according to <2>, in which
a function obtained by modifying the function defining the Gabor filter is a function obtained by modifying the function defining the Gabor filter to add 1 to a term of a trigonometric function in the function defining the Gabor filter.
<4> The information processing system according to claim 3, in which
a function obtained by modifying the function defining the Gabor filter is defined by the following Expression (3):

$$[ Math . 3 ]$$

$${g}_{m} ( x , y , λ , σ , γ , ψ ) = exp ( - \frac{{x}^{′2} + {γ}^{2} {y}^{′ 2}}{2 {σ}^{2}} ) ( cos ( 2 π \frac{{x}^{′}}{λ} + ψ ) + 1 ) \qquad ( 3 )$$

where the predetermined parameters are x, y, λ, σ, γ, and ψ, and among the predetermined parameters, x and y are coordinate positions of pixels, λ is a spatial frequency, σ is a standard deviation of Gaussian, γ is an aspect ratio, and ψ is a phase.
<5> The information processing system according to <1>, in which
the predetermined bit depth is 4 bits or less.
<6> The information processing system according to <1>, in which
difficulty in personal identification of the person based on the digital signal image means that a personal identification rate of the person in the digital signal image is lower than a predetermined value, and
enabling to estimate the attribute by the attribute estimation unit means that estimation accuracy of the attribute by the attribute estimation unit is higher than a predetermined value.
<7> The information processing system according to <1>, in which
a region of a person in the image is at least one of a face region of the person in the image, an upper body region of the person in the image, and a whole body region of the person in the image.
<8> The information processing system according to <1>, in which
the attribute is at least one of body feature information of the person or behavior feature information of the person.
<9> The information processing system according to <8>, in which
the body feature information includes at least one of gender, facial expression, race, number of persons, or information on whether or not the person wears glasses.
<10> The information processing system according to <8>, in which
the behavior feature information includes at least one of a gait, a motion, a face direction, whether or not eyes are opened, or whether or not the person is smiling.
<11> An information processing method for an information processing system including:
an optical filter that converts an image formed on the basis of incident light into a filter image by applying a filter effect set on the basis of a predetermined parameter; and
an imaging element that captures the filter image as an analog signal image including an analog signal, the method including:
performing A/D conversion processing of converting the analog signal image into a digital signal image that is an image including a digital signal by applying A/D conversion processing of a predetermined bit depth to the analog signal image; and
performing attribute estimation processing of estimating an attribute of a person in the image from the digital signal image, in which
the predetermined parameter and the predetermined bit depth are set to make it difficult to identify an individual of the person based on the digital signal image and to enable the attribute to be estimated by the attribute estimation processing.
<12> The information processing method according to <11>, in which
the optical filter converts the image into the filter image by applying the filter effect having an optical characteristic defined by applying the predetermined parameter to a function obtained by modifying a function defining a Gabor filter.
<13> The information processing method according to <12>, in which
a function obtained by modifying the function defining the Gabor filter is a function obtained by modifying the function defining the Gabor filter to add 1 to a term of a trigonometric function in the function defining the Gabor filter.
<14> The information processing method according to <13>, in which
a function obtained by modifying the function defining the Gabor filter is defined by the following Expression (3):

$$[ Math . 3 ]$$

$${g}_{m} ( x , y , λ , σ , γ , ψ ) = exp ( - \frac{{x}^{′2} + {γ}^{2} {y}^{′ 2}}{2 {σ}^{2}} ) ( cos ( 2 π \frac{{x}^{′}}{λ} + ψ ) + 1 ) \qquad ( 3 )$$

where the predetermined parameters are x, y, λ, σ, γ, and ψ, and among the predetermined parameters, x and y are coordinate positions of pixels, λ is a spatial frequency, σ is a standard deviation of Gaussian, γ is an aspect ratio, and ψ is a phase.
<15> The information processing method according to <11>, in which
the predetermined bit depth is 4 bits or less.
<16> The information processing method according to <11>, in which
difficulty in personal identification of the person based on the digital signal image means that a personal identification rate of the person in the digital signal image is lower than a predetermined value, and
enabling to estimate the attribute by the attribute estimation processing means that estimation accuracy of the attribute by the attribute estimation processing is higher than a predetermined value.
<17> The information processing method according to <11>, in which
a region of a person in the image is at least one of a face region of the person in the image, an upper body region of the person in the image, and a whole body region of the person in the image.
<18> The information processing method according to <11>, in which
the attribute is at least one of body feature information of the person or behavior feature information of the person.
<19> The information processing method according to <18>, in which
the body feature information includes at least one of gender, facial expression, race, number of persons, or information on whether or not the person wears glasses.
<20> The information processing method according to <18>, in which
the behavior feature information includes at least one of a gait, a motion, a face direction, whether or not eyes are opened, or whether or not the person is smiling.

It should be understood by those skilled in the art that various modifications, combinations, sub-combinations and alterations may occur depending on design requirements and other factors insofar as they are within the scope of the appended claims or the equivalents thereof.

[Reference Signs List]

| | |
|---|---|
| 31 | Information processing system |
| 51 | Lens |
| 52 | Optical filter |
| 53 | Lens |
| 54 | Image sensor |
| 54a | Imaging element |
| 54b | A/D converter |
| 55 | Attribute estimation unit |
| 56 | Parameter holding unit |

1. An information processing system comprising:
an optical filter that converts an image formed on a basis of incident light into a filter image by applying a filter effect set on a basis of a predetermined parameter;
an imaging element that captures the filter image as an analog signal image including an analog signal;
an A/D converter that applies A/D conversion processing of a predetermined bit depth to the analog signal image to convert the analog signal image into a digital signal image that is an image including a digital signal; and
an attribute estimation unit that estimates an attribute of a person in the image from the digital signal image, wherein
the predetermined parameter and the predetermined bit depth are set to make it difficult to perform personal identification of the person based on the digital signal image, and to enable the attribute estimation unit to estimate the attribute.

2. The information processing system according to claim 1, wherein
the optical filter converts the image into the filter image by applying the filter effect having an optical characteristic defined by applying the predetermined parameter to a function obtained by modifying a function defining a Gabor filter.

3. The information processing system according to claim 2, wherein
a function obtained by modifying the function defining the Gabor filter is a function obtained by modifying the function defining the Gabor filter to add 1 to a term of a trigonometric function in the function defining the Gabor filter.

4. The information processing system according to claim 3, wherein
a function obtained by modifying the function defining the Gabor filter is defined by the following Expression (3):
$$[ Math . 3 ]$$
$${g}_{m} ( x , y , λ , σ , γ , ψ ) = exp ( - \frac{{x}^{′2} + {γ}^{2} {y}^{′ 2}}{2 {σ}^{2}} ) ( cos ( 2 π \frac{{x}^{′}}{λ} + ψ ) + 1 ) \qquad ( 3 )$$
where the predetermined parameters are x, y, λ, σ, γ, and ψ, and among the predetermined parameters, x and y are coordinate positions of pixels, λ is a spatial frequency, σ is a standard deviation of Gaussian, γ is an aspect ratio, and ψ is a phase.

5. The information processing system according to claim 1, wherein
the predetermined bit depth is 4 bits or less.

6. The information processing system according to claim 1, wherein
difficulty in personal identification of the person based on the digital signal image means that a personal identification rate of the person in the digital signal image is lower than a predetermined value, and
enabling to estimate the attribute by the attribute estimation unit means that estimation accuracy of the attribute by the attribute estimation unit is higher than a predetermined value.

7. The information processing system according to claim 1, wherein
a region of a person in the image is at least one of a face region of the person in the image, an upper body region of the person in the image, and a whole body region of the person in the image.

8. The information processing system according to claim 1, wherein
the attribute is at least one of body feature information of the person or behavior feature information of the person.

9. The information processing system according to claim 8, wherein
the body feature information includes at least one of gender, facial expression, race, number of persons, or information on whether or not the person wears glasses.

10. The information processing system according to claim 8, wherein
the behavior feature information includes at least one of a gait, a motion, a face direction, whether or not eyes are opened, or whether or not the person is smiling.

11. An information processing method for an information processing system including:
an optical filter that converts an image formed on a basis of incident light into a filter image by applying a filter effect set on a basis of a predetermined parameter; and
an imaging element that captures the filter image as an analog signal image including an analog signal, the method comprising:
performing A/D conversion processing of converting the analog signal image into a digital signal image that is an image including a digital signal by applying A/D conversion processing of a predetermined bit depth to the analog signal image; and
performing attribute estimation processing of estimating an attribute of a person in the image from the digital signal image, wherein
the predetermined parameter and the predetermined bit depth are set to make it difficult to identify an individual of the person based on the digital signal image and to enable the attribute to be estimated by the attribute estimation processing.

12. The information processing method according to claim 11, wherein
the optical filter converts the image into the filter image by applying the filter effect having an optical characteristic defined by applying the predetermined parameter to a function obtained by modifying a function defining a Gabor filter.

13. The information processing method according to claim 12, wherein
a function obtained by modifying the function defining the Gabor filter is a function obtained by modifying the function defining the Gabor filter to add 1 to a term of a trigonometric function in the function defining the Gabor filter.

14. The information processing method according to claim 13, wherein
a function obtained by modifying the function defining the Gabor filter is defined by the following Expression (3):
$$[ Math . 3 ]$$
$${g}_{m} ( x , y , λ , σ , γ , ψ ) = exp ( - \frac{{x}^{′2} + {γ}^{2} {y}^{′ 2}}{2 {σ}^{2}} ) ( cos ( 2 π \frac{{x}^{′}}{λ} + ψ ) + 1 ) \qquad ( 3 )$$
where the predetermined parameters are x, y, λ, σ, γ, and ψ, and among the predetermined parameters, x and y are coordinate positions of pixels, λ is a spatial frequency, σ is a standard deviation of Gaussian, γ is an aspect ratio, and ψ is a phase.

15. The information processing method according to claim 11, wherein
the predetermined bit depth is 4 bits or less.

16. The information processing method according to claim 11, wherein
difficulty in personal identification of the person based on the digital signal image means that a personal identification rate of the person in the digital signal image is lower than a predetermined value, and
enabling to estimate the attribute by the attribute estimation processing means that estimation accuracy of the attribute by the attribute estimation processing is higher than a predetermined value.

17. The information processing method according to claim 11, wherein
a region of a person in the image is at least one of a face region of the person in the image, an upper body region of the person in the image, and a whole body region of the person in the image.

18. The information processing method according to claim 11, wherein
the attribute is at least one of body feature information of the person or behavior feature information of the person.

19. The information processing method according to claim 18, wherein
the body feature information includes at least one of gender, facial expression, race, number of persons, or information on whether or not the person wears glasses.

20. The information processing method according to claim 18, wherein
the behavior feature information includes at least one of a gait, a motion, a face direction of the person, whether or not eyes are opened, or whether or not the person is smiling.
